(19) United States
(12) Patent Application Publication
(10) Pub. No.: US 2026/0037626 A1
(43) Pub. Date: Feb. 5, 2026

(54) DETECTION OF PHISHING WEBSITES USING MACHINE LEARNING

(71) Applicant: Royal Bank of Canada, Toronto (CA)

(72) Inventors: Syed (Areeb) Akhter, Toronto (CA); Shivam Pandey, Mississauga (CA); Saira Rizvi, Waterloo (CA); Katarina Chiam, Markham (CA); Christian Fowler, Toronto (CA); Cathal Smyth, Toronto (CA); Sahar Rahmani, Toronto (CA); Fariz Huseynli, Toronto (CA); Arsenii Pustovit, Toronto (CA); Milos Stojadinovic, Toronto (CA)

(21) Appl. No.: 19/354,647

(22) Filed: Oct. 9, 2025

Related U.S. Application Data
(63) Continuation of application No. 17/887,037, filed on Aug. 12, 2022, now abandoned.
(60) Provisional application No. 63/237,845, filed on Aug. 27, 2021.

(51) Int. Cl. G06F 21/55; G06N 20/00

(52) U.S. Cl. CPC G06F 21/554; G06N 20/00; G06F 2221/034

(57) ABSTRACT

Salient features are extracted from a training data set. The training data set includes, for each of a subset of known legitimate websites and a subset of known phishing websites, Uniform Resource Locators (URLs) and Hypertext Markup Language (HTML) information. The salient features are fed to a machine learning engine, a classifier engine to identify potential phishing websites is generated by applying the machine learning engine to the salient features, and parameters of the classifier engine are tuned. This enables identification of potential phishing websites by parsing a target website into URL information and HTML information, and identifying predetermined URL features and predetermined HTML features. A prediction as to whether the target website is a phishing website or a legitimate website, based on the predetermined URL features and the predetermined HTML features, is received from the classifier engine.

### CROSS-REFERENCE TO RELATED APPLICATIONS

The present application is a continuation of U.S. patent application Ser. No. 17/887,037,filed on Aug. 12, 2022, and entitled “Detection of Phishing Websites Using Machine Learning”, which claims the benefit of U.S. provisional application Ser. No. 63/237,845, filed on Aug. 27, 2021,and entitled “Detection of Phishing Websites Using Machine Learning”, the entireties of which are hereby incorporated by reference herein.

### TECHNICAL FIELD

The present disclosure is directed at methods, systems, and computer program products for detecting websites associated with phishing attacks.

### BACKGROUND

The term “phishing” refers to a type of fraud used to manipulate individuals into activating a link to a malicious website. These malicious websites may install malware on a user's computing device, or may impersonate the website of a legitimate merchant or financial institution to deceive the victim into entering sensitive information, such as logins, passwords, or bank account and credit card numbers.

The term “phishing” is derived from “fishing” and, like the latter, relies on “bait”. The bait may take the form of an e-mail, text message or the like purporting to be from a trusted party, such as a bank or other financial institution, or an e-commerce or entertainment platform.

In one common example, a message may purport to come from a bank or other financial institution, claiming that the person's account has been locked, and providing a link for the person to “unlock” their account. The link will take the person to a website that is designed to mimic the bank's website, with fields for the user to enter their credentials (e.g. user name and password, and possibly bank account details). In fact, the website is fraudulent, and once the user has provided their details, these are captured for use by the miscreant operators in conducting illicit transactions with the user's account, which may be drained before the treachery is discovered.

Another common example is for the scoundrels to send a message claiming to be from an e-commerce or entertainment platform, and indicating that there was a problem with a payment. Again, a link is provided, which takes the recipient to an imposter website, where they are asked to enter login information and payment information, which is captured and put to misuse.

These are merely a few common examples, and are by no means limiting; there are a wide range of phishing schemes in use and more are being developed. The resourcefulness of greedy, dastardly blackguards knows few bounds, and the messages can be highly manipulative and effective. Thus, it is an ongoing challenge to defend against phishing.

Many existing security products are of limited effectiveness in protecting clients from phishing attacks. They take a broad approach, and typically do not prioritize a user's financial accounts, which may create exposure to more sophisticated attacks that are targeted to users of a particular financial institution.

### SUMMARY

According to a first aspect, there is provided a method for building a classifier engine to identify potential phishing websites. The method comprises extracting salient features from a training data set, wherein the training data set includes, for each of a subset of known legitimate websites and a subset of known phishing websites, Uniform Resource Locators (URLs) and Hypertext Markup Language (HTML) information. The method further comprises feeding the salient features to a machine learning engine, generating a classifier engine by application of the machine learning engine to the salient features, and tuning parameters of the classifier engine.

In a preferred embodiment, the classifier engine is specific to a particular institution and the salient features include at least one institution-specific feature associated with the particular institution. In certain particular embodiments, the institution-specific feature(s) may include at least one of a text string including at least a portion of a name of the institution, a text string including a typographically imperfect recreation of at least a portion of the name of the institution, a text string including at least a portion of a trademark of the institution, a text string including a typographically imperfect recreation of at least a portion of a trademark of the institution, a text string including at least a portion of contact information for the institution, a text string including a typographically imperfect recreation of at least a portion of contact information for the institution, a graphical representation of an image associated with the institution, and a graphical representation of an imperfect recreation of an image associated with the institution.

In another aspect, there is provided a method for identifying potential phishing websites. The method comprises receiving a target website, parsing the target website into Uniform Resource Locator (URL) information and Hypertext Markup Language (HTML) information, identifying predetermined URL features of the URL information, identifying predetermined HTML features of the HTML information, and receiving, from a classifier engine, a prediction as to whether the target website is a phishing website or a legitimate website, wherein the prediction is based on the predetermined URL features and the predetermined HTML features.

Preferably, the method further comprises, where the prediction predicts that the target website is a phishing website, blocking access to the target website.

In one preferred embodiment, the classifier engine is specific to a particular institution and the classifier engine is trained using salient features that include at least one institution-specific feature associated with the particular institution. In certain particular embodiments, the institution-specific feature(s) may include at least one of a text string including at least a portion of a name of the institution, a text string including a typographically imperfect recreation of at least a portion of the name of the institution, a text string including at least a portion of a trademark of the institution, a text string including a typographically imperfect recreation of at least a portion of a trademark of the institution, a text string including at least a portion of contact information for the institution, a text string including a typographically imperfect recreation of at least a portion of contact information for the institution, a graphical representation of an image associated with the institution, and a graphical representation of an imperfect recreation of an image associated with the institution.

In some embodiments, the method further comprises comparing the URL information to at least one predefined list of URLs, and, responsive to determining that the URL information corresponds to one of the URLs contained in the at least one predefined list of URLs, definitively identifying the target website as one of a legitimate website and a phishing website according to the predefined list of URLs in which the one of the URLs is contained. The predefined list(s) of URLs may includes a blacklist of known phishing websites and/or a whitelist of known legitimate websites. In such embodiments, the method may definitively identify the target website as a legitimate website where the URL information corresponds to one of the URLs contained in the whitelist, and/or definitively identify the target website as a phishing website where the URL information corresponds to one of the URLs contained in the blacklist. Preferably, the method further comprises, responsive to definitively identifying the target website as a phishing website, blocking access to the target website.

In some embodiments, the method is performed for a plurality of remote computing devices, and the method further comprises, where the target website is predicted to be a phishing website, using a number of times unique individuals attempt to access the target website to estimate a size of a phishing campaign associated with the target website.

In another aspect, there is provided a method for identifying overtrusting website engagement. The method comprises monitoring target websites requested by at least one IP address associated with a unique individual, detecting at least one phishing website among the target websites, determining an overtrust score for the individual, wherein the overtrust score is determined from the phishing websites detected among the target websites, comparing the overtrust score to an overtrust threshold, and responsive to a determination that the overtrust score satisfies the overtrust threshold, initiating overtrust remediation.

In one embodiment, the overtrust remediation includes locking at least one financial account associated with the individual.

In some embodiments, the overtrust score is a weighted score that is weighted according to sophistication of each of the phishing website(s) detected among the target websites. In other embodiments, the overtrust score is a number of phishing websites detected among the target websites.

In some embodiments, the phishing websites are detected by comparison to a blacklist and/or by use of a classification engine.

In other aspects, the present disclosure is directed to data processing systems and computer program products for implementing the above-described methods.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows a computer network that comprises an example embodiment of a system for detecting websites associated with phishing attacks;

FIG. 2 depicts an example embodiment of a server in a data center;

FIG. 3 shows an illustrative method for identifying potential phishing websites;

FIG. 4 shows an illustrative distributed architecture for implementing the method of FIG. 3;

FIG. 4A shows an illustrative local architecture for implementing the method of FIG. 3;

FIG. 5 shows an illustrative data flow model for the method of FIG. 3;

FIG. 6 shows an illustrative user flow for a user through a system implementing the method of FIG. 3;

FIG. 6A shows an illustrative blocking pop-up in a graphical user interface;

FIG. 7 shows an illustrative method for building a classifier engine to identify potential phishing websites;

FIG. 8 shows an illustrative method for identifying overtrusting website engagement; and

FIG. 9 shows an illustrative graphical user interface (GUI) for web a browser extension according to an aspect of the present disclosure.

### DETAILED DESCRIPTION

Broadly speaking, the present disclosure describes a system, method and computer program product to detect and protect against phishing attacks. In one aspect, the system may comprise a machine learning model and a customer-facing web browser extension (e.g. accessible via an app store such as the Google Chrome web store). The web browser extension may be for a desktop computer, or for a mobile device, such as a smartphone or tablet using a mobile version of a web browser, for example Safari Mobile for iOS or Chrome for Android, among others.

A website contains two easily accessible pieces of information: its Uniform Resource Locator (URL), and the Hypertext Markup Language (HTML) code which defines the components that appear on the webpage. In one implementation, the machine learning model is a classification model that uses this information to predict whether the website is a phishing website or a legitimate website. The browser extension is a client-facing tool that supports validation of whether target websites (those the user attempts to visit) are likely to be phishing sites by using an application programming interface (API) to communicate with a server-hosted classifier engine implementing a machine learning model that evaluates the website features. Based on the prediction from the server-hosted machine learning model, the browser extension acts with the appropriate measure of urgency to inform and protect the user. While a server-hosted machine learning model is preferred, in other embodiments the model may, for example, be hosted locally and updated periodically.

In one illustrative embodiment, a frontend, such as the browser extension, extracts specific features from the target website information (URL and HTML code); these features are sent to a vectorizer, which presents the extracted features in an array, which is then sent to the server. At the server, the array is input to a classifier engine implementing a machine learning model, and the classifier engine uses the array to predict whether the target website is likely to be a phishing website. In a particularly preferred embodiment, the classifier engine is specifically tuned to predict whether the target website is impersonating a particular institution, such as a specific bank or financial institution, or a specific e-commerce or entertainment platform. In alternate embodiments, a frontend, such as the browser extension, sends the target website information (or the URL identifying the target website) to the server, where the server extracts the features from the target website information and sends them to the vectorizer.

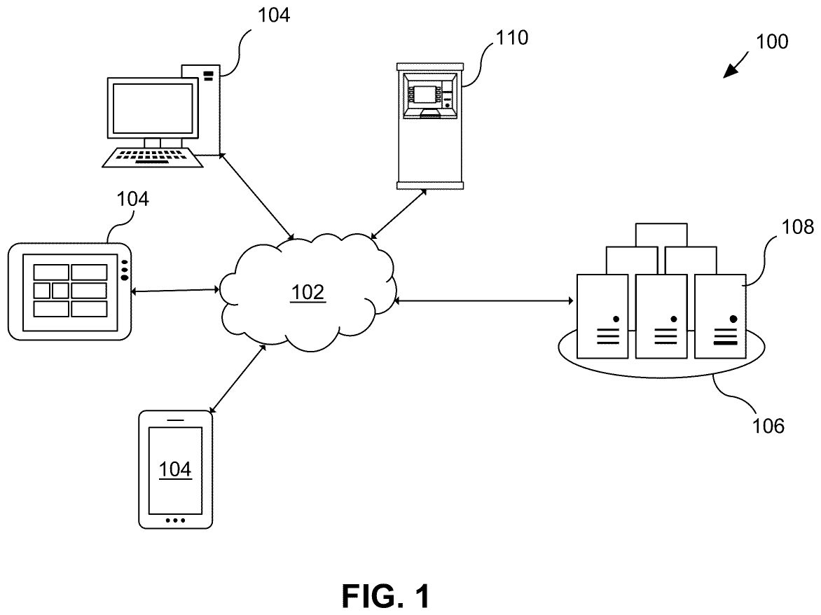

Referring now to FIG. 1, there is shown a computer network 100 that comprises an example embodiment of a system for detecting websites associated with phishing attacks. More particularly, the computer network 100 comprises a wide area network 102 such as the Internet to which various client devices 104, an ATM 110, and data center 106 are communicatively coupled. The data center 106 comprises a number of servers 108 networked together to collectively perform various computing functions. For example, in the context of a financial institution such as a bank, the data center 106 may host online banking services that permit users to log in to those servers using user accounts that give them access to various computer-implemented banking services, such as online fund transfers. Furthermore, individuals may appear in person at the ATM 110 to withdraw money from bank accounts controlled by the data center 106.

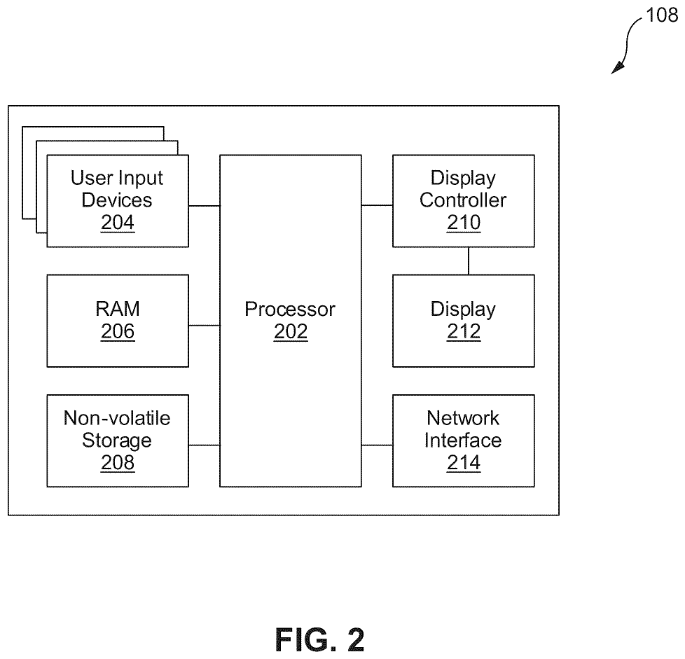

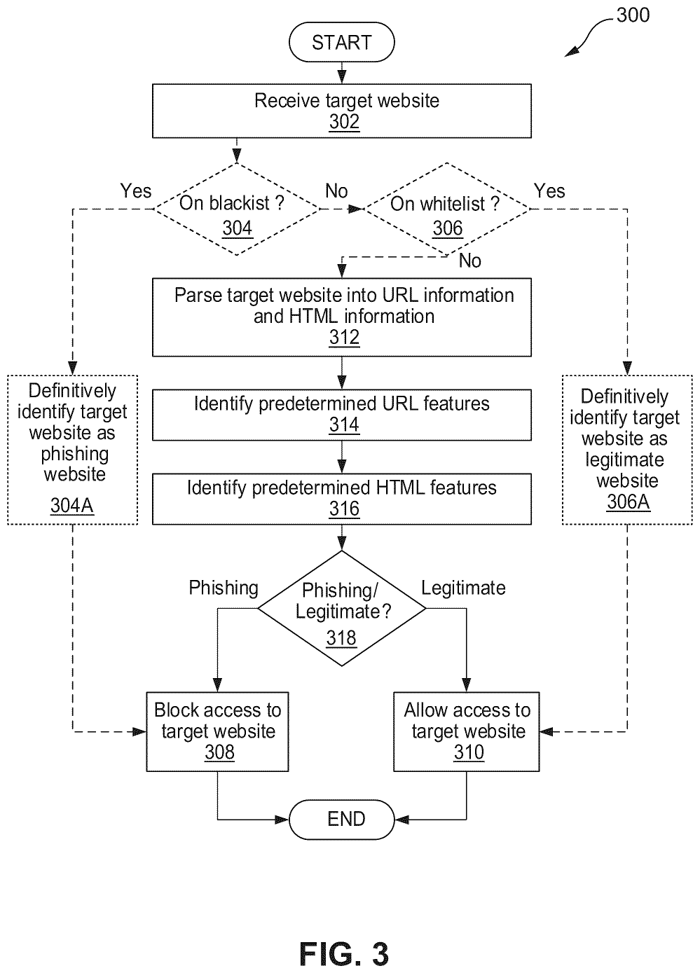

Referring now to FIG. 2, there is depicted an example embodiment of one of the servers 108 that comprises the data center 106. The server comprises a processor 202 that controls the overall operation of the server 108. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code loaded into the RAM 206 at runtime; a display controller 210, which is communicatively coupled to and controls a display 212; and a network interface 214, which facilitates network communications with the wide area network 102 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement a method for identifying potential phishing websites such as is described in more detail in respect of FIG. 3 below. Additionally or alternatively, the servers 108 may collectively perform that method using distributed computing. While the system depicted in FIG. 2 is described specifically in respect of one of the servers 108, analogous versions of the system may also be used for the client devices 104.

Reference is now made to FIG. 3, which shows an illustrative method for identifying potential phishing websites, indicated generally by reference 300.

At step 302, the method 300 receives a target website. For example, a user may have clicked on a link in an e-mail or in a text message, and before opening the target website represented by the link, the browser extension on the client's computing device may pass the target website to a server system implementing a server-hosted machine learning model (e.g. a server-hosted classifier engine). This may be, for example, one or more of the servers 108 in the data center 106, which receives the target website from a client device 104. Alternatively, before opening the target website represented by the link, the browser extension may pass the target website to a local implementation of a machine learning model (e.g. a locally-executed classifier engine) running on the client device 104. The target website may be passed by passing the URL, or by encapsulating the URL and the associated HTML code (and possibly other Document Object Model (DOM) information, as discussed below).

In some embodiments, the method 300 comprises comparing the URL information to at least one predefined list of URLs. For example, the method 300 may compare the URL information to a blacklist of known phishing websites at optional step 304 or to a whitelist of known legitimate websites at optional step 306, or both. Steps 304 and 306 may take place in reverse order, or substantially simultaneously. This comparison may take place on the client side, for example within the browser extension, or on the server side, for example as a preliminary step before application of the machine learning model by the classifier engine, or as part of the machine learning model. Where steps 304 and 306 take place on the server side, suitable privacy protections are preferably deployed, for example hashing of the URLs before transmission to the server. In all cases, applicable privacy law should be complied with. Responsive to determining that the URL information corresponds to one of the URLs contained in a predefined list of URLs, the method 300 definitively identifies the target website as a legitimate website or a phishing website, according which predefined list of URLs contains the URL of the target website. Thus, at step 304A the method 300 definitively identifies the target website as a phishing website where the URL information corresponds to one of the URLs contained in the blacklist (“yes” at step 304), or, at step 306A the method 300 definitively identifies the target website as a legitimate website where the URL information corresponds to one of the URLs contained in the whitelist (“yes” at step 306). Responsive to definitively identifying the target website as a phishing website at step 304A, the method 300 blocks access to the target website at step 308. Conversely, responsive to definitively identifying the target website as a legitimate website at step 306A, the method 300 allows access to the target website at step 310. The use of a blacklist and/or whitelist acts as a filter, and can improve processing by avoiding the need to invoke a classifier engine where the character of the target websites can be immediately determined from past experience with that exact URL.

The blacklist and whitelist may be obtained in a variety of ways. For example, certain security providers offer a blacklist service, with an associated API. For example, PhishLabs, having an address at 1501 King Street, Charleston, SC 29405 U.S.A. and RSA Security LLC, having an address at 176 Middlesex Turnpike, Bedford, MA 01730 U.S.A. provide blacklists. A whitelist may be limited to websites that are hosted by the institution (e.g. only the institution's own web pages) and therefore known to be legitimate, or may also include external websites determined to be legitimate, which may be compiled manually. For example, certain popular social media websites, news websites, and the like may be manually vetted and added to the whitelist. Optionally, the blacklist and whitelist may be hashed, for example using RSA's MD5 algorithm. Optionally, the blacklist and/or the whitelist may be dynamically regenerated or updated to track evolving threats. For example, where confidence is high that a particular website is a phishing website (e.g. a confidence level in a prediction by the classifier engine exceeds a threshold), that website may be automatically added to the blacklist.

If the target website is not on the blacklist (“no” at step 304) and is not on the whitelist (“no” at step 306), the method 300 proceeds to step 312. At step 312, the method 300 parses the target website into Uniform Resource Locator (URL) information and Hypertext Markup Language (HTML) information. The HTML information may be represented using the Document Object Model (DOM), which is a W3C standard providing a programming API for HTML and XML documents; the DOM model may contain additional information as well, such as CSS information. Step 312 may be implemented by the server, or may be implemented by the browser extension before passing the website to the server (or the entire method 300 may be implemented on a client device using a locally-executing classifier engine forming part of, or cooperating with, a browser extension).

At step 314, the method 300 identifies predetermined URL features of the URL information, and at step 316, the method 300 identifies predetermined HTML features of the HTML information (additional DOM features may also be identified at step 316). The predetermined URL features and the predetermined HTML features (and possibly other DOM features) are those that are relevant to the trained machine learning model implemented by the classifier engine. Steps 314 and 316 may be performed in reverse order, or substantially simultaneously.

At step 318, the method 300 receives, from the classifier engine, a prediction as to whether the target website is a phishing website or a legitimate website. The classifier engine implements a trained machine learning model to generate the prediction, which is based on the predetermined URL features and the predetermined HTML features. Where the prediction from the classifier engine at step 318 is that the target website is a phishing website, the method 300 proceeds to step 308 to block access to the target website. Where the prediction from the classifier engine at step 318 is that that the target website is a legitimate website, the method 300 proceeds to step 310 and allows access to the target website.

Importantly, in particularly preferred embodiments, the classifier engine is specific to a particular institution, and the classifier engine is trained using salient features that include at least one institution-specific feature associated with the particular institution. For example, in preferred embodiments the institution-specific feature(s) may include specific text strings and/or graphical representations, as described further below.

Optionally, where the method 300 is performed for a plurality of remote computing devices (e.g. client devices 104), where the target website is predicted to be a phishing website, the method 300 may use a number of times unique individuals attempt to access the target website to estimate the size of the phishing campaign associated with the target website. The term “unique”, in this context, means that multiple attempts to access a particular target website from the same computing device (e.g. same IP address) would only count once-whether the individual associated with that computing device tried to access the target website a single time or multiple times, that individual represents a single recipient of the phishing campaign.

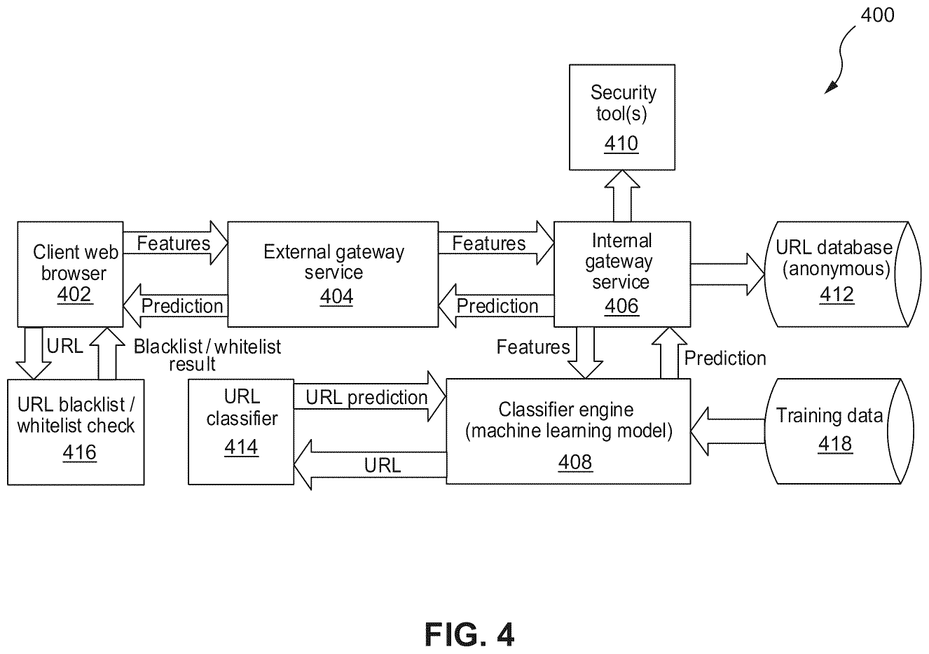

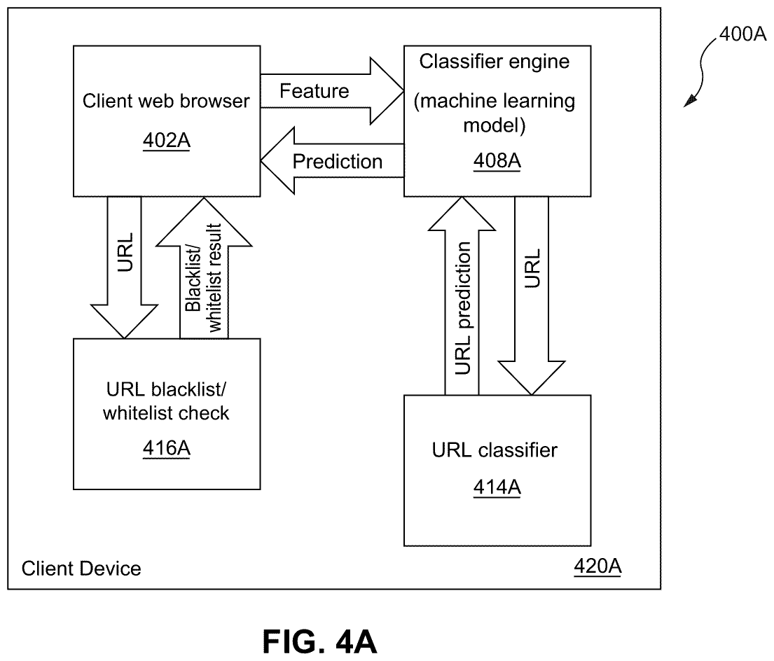

Reference is now made to FIG. 4, which shows an illustrative distributed architecture for implementing the method 300. The architecture shown in FIG. 4, indicated generally by reference 400, is merely one illustrative implementation, and is not intended to be limiting.

In the illustrative architecture 400, a client web browser 402 communicates, through an external gateway service 404 and an internal gateway service 406, with a classifier engine 408 that implements a trained machine learning model. The internal gateway service 406 also communicates with one or more internal security tools 410 and an anonymous URL database 412. The anonymous URL database 412 may be used to store URLs for websites that have been identified as phishing websites to support trend analysis, using a suitable anonymization or other privacy technique to protect user privacy. The classifier engine 408 communicates with a URL classifier module 414 and a training database 418, and the client web browser 402 communicates with a blacklist/whitelist checking module 416.

Upon receiving a request to access a target website, the client web browser 402 passes the URL information for the target website to the blacklist/whitelist module 416, which indicates whether the URL information corresponds to the blacklist or the whitelist. If the blacklist/whitelist module 416 determines that URL information corresponds to the blacklist or the whitelist, this is reported back to the client web browser 402, which can then definitively identify the target website as either a phishing website (blacklist) or a legitimate website (whitelist). If the blacklist/whitelist module 416 determines that URL information does not correspond to either the blacklist or the whitelist, this is also communicated to the client web browser 402. The client web browser 402 then extracts the salient features from the URL information and the HTML information and passes them through the external gateway service 404 and the internal gateway service 406 to the classifier engine 408, which is located on a server remote from the client device implementing the client web browser 402. In an alternate embodiment, the client web browser 402 may simply pass the URL through the external gateway service 404 and the internal gateway service 406 to the classifier engine 408, since the HTML information will be accessible via the URL.

The classifier engine 408 passes the URL information to the URL classifier module 414, which returns a prediction as to whether the target website is a phishing website or a legitimate website; this is referred to as a “URL prediction” as it is based on the URL information alone. The classifier engine 408 then applies the trained machine learning model to the URL prediction and the HTML information to generate a prediction as to whether the target website is a phishing website or a legitimate website. This prediction is then returned, through the internal gateway service 406 and the external gateway service 404, to the web browser 402 for appropriate action. In alternate embodiments, the URL classifier module 414 may be integrated into the classifier engine 408 or omitted, such that the classifier engine generates its prediction using the URL information without an independent URL prediction. Also, as noted above, in alternative architectural configurations the comparison of the URL information to the blacklist and/or the whitelist may occur elsewhere, for example within the classifier engine 408.

Load balancing may be supported, for example, by caching of frequently and recently accessed websites, restrictions on requests from each IP address, or limiting requests from certain subsets of users. Suitable algorithms such as Least Connections or IP Hashing may be used, for example through a platform such as NGINX, to support scalability.

Optionally, privacy support may be provided, for example, by encrypting the data sent from the client web browser 402 and encrypting the prediction from the classifier engine 408.

FIG. 4A shows an illustrative local architecture for implementing the method 300. Unlike the distributed architecture shown in FIG. 4, in which the classifier engine 408 and URL classifier module 414 are located on a server remote from a client device, in the local architecture 400A shown in FIG. 4A, the classifier engine 408A and URL classifier module 414A are located on the same client device 420A that executes the client web browser 402A.

When the client web browser 402A receives a request to access a target website, it passes the URL information for the target website to the blacklist/whitelist module 416A, which returns an indication of whether the URL information corresponds to the blacklist or the whitelist, which is reported back to the client web browser 402A. The client web browser 402A can then definitively identify the target website as either a phishing website (blacklist) or a legitimate website (whitelist). Conversely, where the blacklist/whitelist module 416A determines that URL information does not correspond to either the blacklist or the whitelist, this is also communicated to the client web browser 402A. Where the URL information does not correspond to either the blacklist or the whitelist, the client web browser 402A then extracts the salient features and passes them to the classifier engine 408A, which is also executing on the client device 420A along with the URL classifier module 414A. The classifier engine 408A passes the URL information to the URL classifier module 414A, which returns a URL prediction as to whether the target website is a phishing website or a legitimate website. The classifier engine 408A then applies the machine learning model to the URL prediction and the HTML information, and generates a prediction as to whether the target website is a phishing website or a legitimate website. The classifier engine 408A then returns this prediction to the web browser 402A for appropriate action. As noted above in the context of the distributed architecture 400, in the local architecture 400A, the URL classifier module 414A may likewise be integrated into the classifier engine 408A or omitted, such that the classifier engine generates its prediction without an independent URL prediction. Also, as noted above, in alternative architectural configurations the comparison of the URL information to the blacklist and/or the whitelist may occur elsewhere, for example within the classifier engine 408A. The local architecture shown in FIG. 4A is merely one illustrative implementation, and is not intended to be limiting.

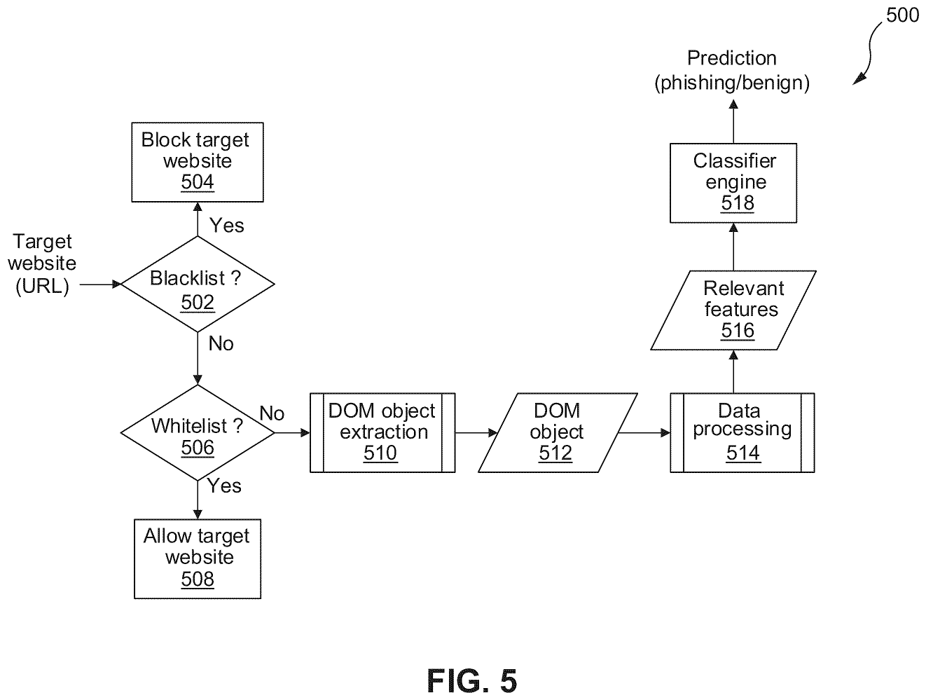

FIG. 5 shows an illustrative data flow model, indicated generally by reference 500, for the method 300. Again, this is merely one illustrative data flow, and is not intended to be limiting. A URL representing a target website is received, and passed to decision block 502, which tests whether the URL is in the blacklist. If the URL is in the blacklist (“yes” at decision block 502), the target website is blocked at step 504. If the URL is not in the blacklist (“no” at decision block 502), the URL is passed to decision block 506, which tests whether the URL is in the whitelist. If the URL is in the whitelist (“yes” at decision block 506), the target website is allowed at step 508. If the URL is not in the whitelist (“no” at decision block 506), the URL is passed to block 510, which extracts HTML information, which in the illustrated embodiment is represented as a DOM object 512. The DOM object 512, as well as the original URL, are passed to block 514 to undergo data processing to extract the relevant features 516, which are then passed to a classifier engine 518 to generate a prediction as to whether the target website is a legitimate (benign) website or a phishing website. This prediction can then be returned to the browser extension, for example, to enable blocking of, or access to, the target website, and the prediction may be used as input to enhance existing security tools, or as feedback to support user education.

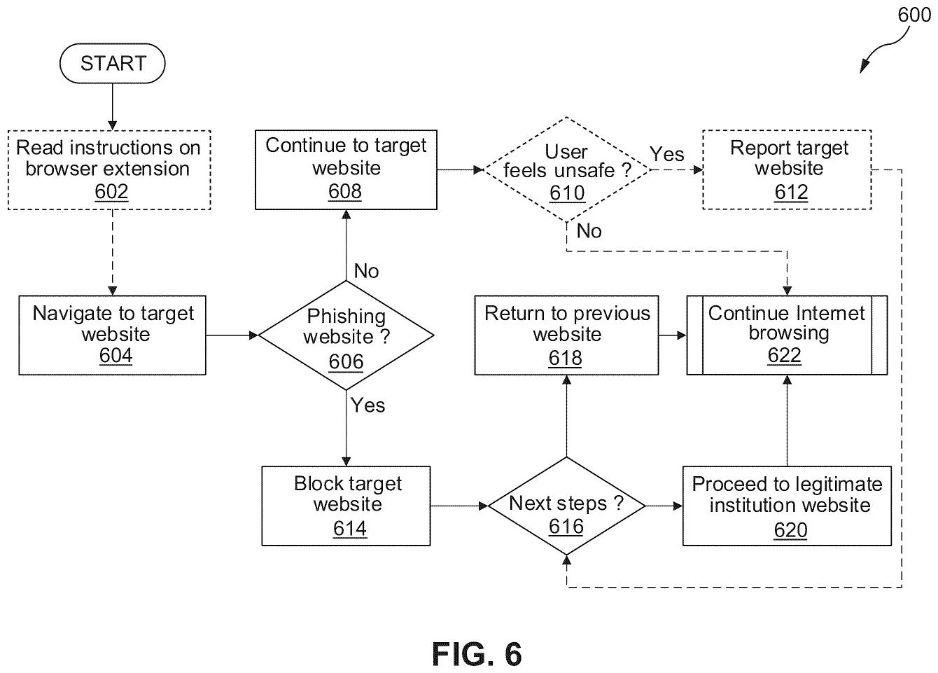

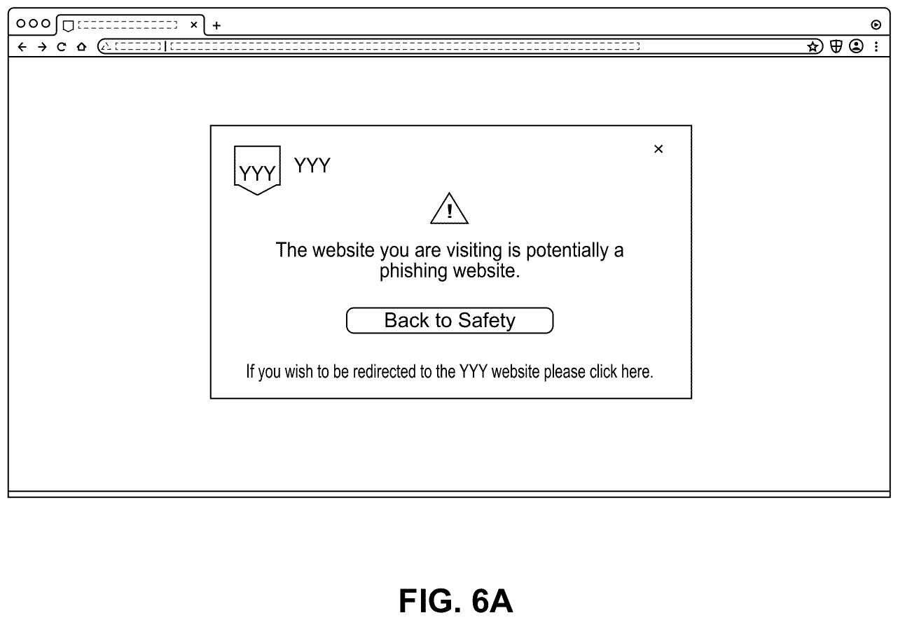

Reference is now made to FIG. 6 which shows an illustrative user flow, denoted by reference 600, for how a user would move through a system implementing the method 300. Again, this is merely one illustrative user flow, and is not intended to be limiting. From the perspective of a user, after optionally reading instructions on the browser extension functionality at block 602, the user attempts to navigate to a target website at block 604. For example, the user may click on a link in an e-mail or other message, or may enter the URL for the target website directly into the browser address bar. At decision block 606, based on the prediction from the classifier engine, it is determined whether the target website is a phishing website.

If the target website is determined not to be a phishing website (“no” at decision block 606) then at block 608 the user is permitted to continue to the target website. Optionally, at decision block 610 the user can be provided with an option to manually flag the target website as possibly unsafe, even if not identified as a phishing website at decision block 606. Machine learning is not infallible. If the user manually flags the target website as possibly unsafe (“yes” at decision block 610) then at step 612 the target website can be reported to the party responsible for the method 300 (FIG. 3) for manual evaluation and possible further action. The user then returns to step 616. Otherwise, the user continues to step 622.

If the target website is determined to be a phishing website (“yes” at decision block 606) then at block 614 the target website will be blocked, for example by a pop-up window, and the user is provided with options for further navigation at decision block 616. For example, the user may be provided with an option to return to the previous website at block 618, or an option at block 620 to proceed directly to the legitimate website of a financial institution administering the method 300 (FIG. 3). An illustrative blocking pop-up is shown in FIG. 6A. From the user's perspective, the flow paths converge on continued Internet browsing at block 622.

Optionally, where the classifier engine determines that a target website is a phishing website (“yes” at decision block 606 in FIG. 6), relevant information may be fed back into an existing cybersecurity network for cross-validation, which may allow security teams to build up a more detailed profile of threat actor patterns.

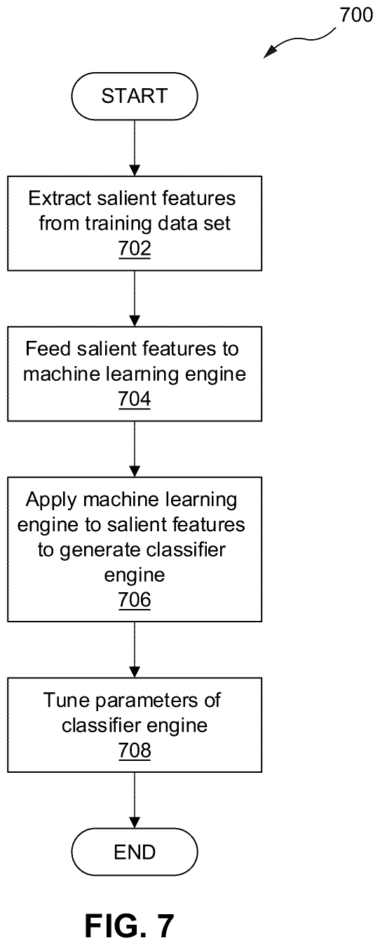

Reference is now made to FIG. 7, which shows an illustrative method, denoted generally by reference 700, for building a classifier engine to identify potential phishing websites.

At step 702, the method 700 extracts salient features from a training data set. The training data set includes Uniform Resource Locators (URLs) and Hypertext Markup Language (HTML) information for a subset of known legitimate websites and a subset of known phishing websites. The HTML information may be represented using the Document Object Model (DOM), which may contain additional information as well, such as CSS information. In one embodiment, the subset of known phishing websites may be obtained from commercially obtained blacklists (e.g. PhishLabs and RSA Security noted above, among others), and the subset of known legitimate websites may be obtained from a previously defined whitelist, or may be manually compiled. For example, the subset of known legitimate websites may include an institution's own website(s), and may optionally include other websites determined to be legitimate. For example, the verified sign-in pages from other established financial institutions may be used as part of the subset of known legitimate websites.

In one embodiment, a data processing class feature_extractor takes cach of the websites and extracts, for each website, the URL features and HTML features that will form the salient features fed to the machine learning engine. The HTML features may be categorized as HTML login form features, and HTML text features, which may include keywords. In one embodiment, a webscraper uses the requests Python package and makes a simple GET request to the URL to collect the HTML. The data is then stored as a Json (JavaScript object encoding) file, which is converted into a NumPy array using the scikit-learn vectorizers DictVectorizer (dictionary vectorizer) and TfidfVectorizer (TFIDF vectorizer). The URL features are converted to one hot encoding (using DictVectorizer) and the HTML features, comprising token frequency contained in the HTML, are converted to TFIDF scores (using TfidfVectorizer) the Sklearn TFIDF vectorizer.; the DictVectorizer and TfidfVectorizer outputs are joined to form an array in which the DictVectorizer output comes before the TfidfVectorizer output. The scikit-learn vectorizers DictVectorizer and TfidfVectorizer are available at scikit-learn.org.

The URL features may be a mixture of Boolean (true/false) values reflecting characteristics of the URL, and numerical counts of certain features within the URL. These will vary based on the domain, and will generally be characteristics and features that are empirically observed to be relevant as potential badges of fraud. Similarly, HTML login form features may be Boolean values and/or numerical counts of features associated with opportunities for users to submit information. Again, these will generally be characteristics and features that are empirically observed to be relevant as potential badges of fraud.

One example of a URL feature that may tend to indicate whether a website is a phishing site is whether the domain is a textual domain name or numerical IP address, which can be represented as a Boolean value. Legitimate websites are more likely to have a textual domain name, for example the legitimate website for “YYY Bank” may have the domain name “yyybank.com” whereas a phishing website is more likely to have a numerical IP address such as “http://xxx.xxx.xxx.xx/” where each “x” represents a numerical digit. “YYY Bank” is a fictional bank for illustrative purposes and is not intended to represent any actual financial institution.

One example of an HTML text feature is a TFIDF score. The term “TFIDF” stands for term frequency-inverse document frequency. The TFIDF statistic is designed to represent numerically the importance of a word to a document within a larger body of documents. The value of the TFIDF statistic will increase in proportion to the number of appearances of a particular word within a document, but is offset according to the total number of documents in the body of documents where that same word is found, in order to account for the general word frequency. In one embodiment, words used to compute TFIDF scores may be obtained by analysis of known phishing websites that are relevant to the specific institution that will deploy the classifier engine and related tools. The words may be relevant to phishing generally, such as “account”, “PIN”, “password” or “SSN”, or specific to the industry of the specific institution, for example “MP3” for a music streaming or download website, or specific to the institution itself, for example a trademark or business name of the institution. The latter two would be examples of institution-specific features associated with the particular institution, in the first case because of the industry generally and in the second case because they are specific identifiers for the institution itself. Another example of an HTML text feature is a specific character string in the URL itself or the HTML title tag; again these may be relevant to phishing generally, specific to the industry of the specific institution, or specific to the institution itself. For example, given the institution “YYY Bank”, the text strings “YYY” and “YYY Bank” appearing in the URL or HTML title tag would be examples of institution-specific features. “YYY Bank” is a fictional bank for illustrative purposes and is not intended to represent any actual financial institution.

The list of features above is illustrative and not limiting; in other contexts, features may be added, substituted, omitted or modified.

For example, in some embodiments, salient features may relate to uniform transformation format (UTF) codes across the HTML text for English and French language keyboards, analysis of website certificates for legitimacy, and assessing changes in DOM information (e.g. by hashing) for cases where JavaScript loads features with a delay.

At step 704, the method 700 feeds the salient features to a machine learning engine. In one embodiment, the machine learning engine is XGBoost. XGBoost is a gradient boosted decision tree machine learning algorithm that can be used for supervised learning tasks including classification problems. The gradient boost uses gradient descent to minimize loss at each iteration as new models are generated. In one embodiment, the training/testing split is 80/20, with decision tree algorithms splitting the data based on its attributes at each iteration. XGBoost is merely an illustrative example, and any suitable machine learning engine may be used. Examples of other suitable machine learning engines include, but are not limited to, logistic regression, neural network, and random forest.

At step 706, the method 700 generates a classifier engine by application of the machine learning engine to the salient features. The input to the machine learning engine is the salient features (such as those listed above) transformed into a NumPy array, and the output is a predicted class, i.e. legitimate website or phishing website. In one embodiment, the performance metrics used are: accuracy, precision, recall, fl-score, support, confusion matrix and ROC curve, and errors are identified for analysis.

At step 708 the method 700 tunes the parameters of the classifier engine. In one embodiment, hyperparameter tuning was completed with 5-fold cross-validation with 60 parameter combinations using a randomized grid search (e.g. a nested for loop) by adjusting the following:
learning_rate;
max_depth;
min_child_weight;
gamma;
colsample_bytree; and subsample.

Preferably, the classifier engine is continuously updated, for example using an automated training pipeline, to enhance detection of the latest phishing attacks.

As noted above in the discussion of the illustrative method 300 for identifying potential phishing websites, in particularly preferred embodiments, the classifier engine is specific to a particular institution, and the classifier engine is trained using salient features that include at least one institution-specific feature associated with the particular institution. The institution may be, for example, a bank or other financial institution. For example, in preferred embodiments the institution-specific feature(s) may include specific text strings and/or graphical representations. The text string may be a true text string or may be a text string that is extracted from an image, such as by optical character recognition. The features can include text strings for names (the term “name” including abbreviations), trademarks, and contact information for the institution, as well as graphical representations of images associated with the institution, which may include a trademark/logo, a commonly used picture, or a celebrity endorser or mascot, each of which may be identified, for example, using AI-assisted image classifier software. Additionally, the features may include imperfect recreations, such as intentional typographical errors or intentional lack of fidelity in images. Accordingly, examples of institution-specific features may include:
a text string including at least a portion of a name of the institution;
a text string including a typographically imperfect recreation of at least a portion of the name of the institution;
a text string including at least a portion of a trademark of the institution;
a text string including a typographically imperfect recreation of at least a portion of a trademark of the institution;
a text string including at least a portion of contact information for the institution;
a text string including a typographically imperfect recreation of at least a portion of contact information for the institution;
a graphical representation of an image associated with the institution; and.
a graphical representation of an imperfect recreation of an image associated with the institution.

Where institution-specific features include graphical representations, aspects that may be considered include the number of images, the percentage of a website taken up by a particular image, or by images in general, as well as colour analysis (e.g. looking at the CSS to compare the hexadecimal code for a color used in the target website to the hexadecimal code for a trademark colour used by the institution). Favicon analysis may also be deployed. A favicon is a file containing one or more icons associated with a website, which can be displayed in the address bar (among other locations) of a web browser with favicon support. A website that is not actually associated with an institution would not have a legitimate reason to use a favicon associated with that institution, and such use may be a badge of fraud.

Similarly, use of a text string representing a trademark of an institution may, when used by a different entity, be a potential indicator of fraud, although there may be legitimate instances of such use, for example in a product review or a news report.

These are merely examples, and are not intended to imply any limitation on the institution-specific features that may be used in training a classifier engine according to the present disclosure.

Without being limited by theory, it is believed that providing a classifier engine that is trained using salient features that include institution-specific feature(s) associated with a particular institution may provide improvements in detecting attacks that are targeted against such an institution. Thus, while a user is unlikely to be effectively deceived by, for example, a phishing e-mail purporting to come from a financial institution they do not use (e.g. a bank where they do not have any account), the likelihood of effective deception is higher if the phishing e-mail purports to come from a financial institution where they do business. Increased effectiveness in detecting targeted phishing attacks against a particular institution may be critical in this context.

In another aspect, the present disclosure provides a method for identifying overtrusting website engagement. The term “overtrusting”, as used in this context, indicates that a user is too willing to engage with or “trust” a website that is determined to be a phishing website, which may expose the user to harm.

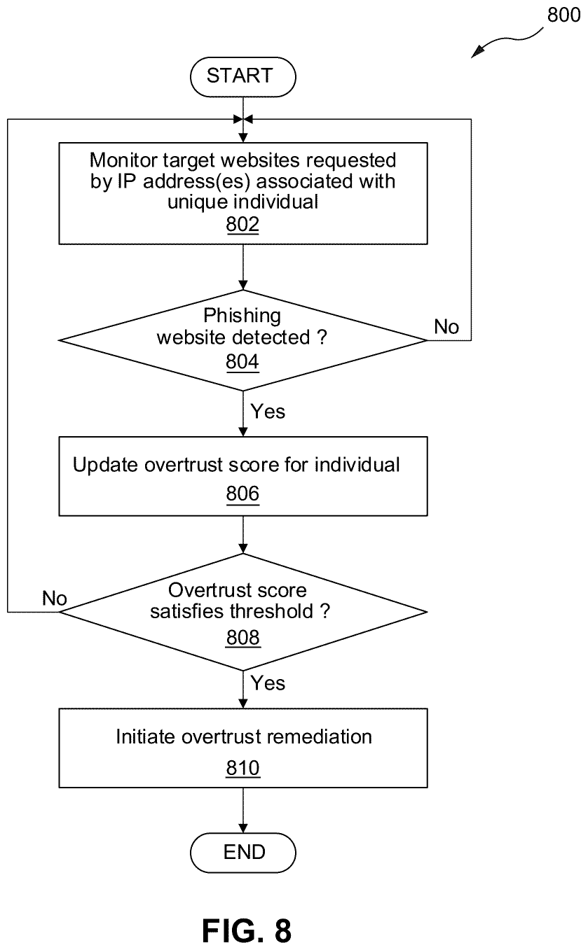

Reference is now made to FIG. 8, in which an illustrative method for identifying overtrusting website engagement is indicated generally at reference 800. At step 802, the method 800 monitors target websites requested by at least one IP address associated with a unique individual. At step 804, the method 800 tests whether a phishing website is detected among the target websites. The phishing website(s) may be detected, for example, by comparison to a blacklist and/or use of a classification engine as described above. If no phishing website is detected (“no” at step 804), the method 800 returns to step 802 and continues monitoring. If a phishing website is detected (“yes” at step 804), the method 800 proceeds to step 806 to update an overtrust score for the individual. In a first instance of step 806, an initial overtrust score may be generated. The overtrust score is determined from the phishing websites detected among the target websites. The overtrust score may be, for example, the number of phishing websites detected among the target websites, i.e. a count of the number of phishing websites that the individual tried to visit, or a weighted score that is weighted according to the sophistication of each of the phishing websites detected among the target websites. For example, less sophisticated phishing websites may be assigned a higher weight, as an attempt to visit a less sophisticated phishing website indicates that the user is more overtrusting.

The method proceeds from step 806 to step 808, where the overtrust score is compared to an overtrust threshold. Responsive to a determination that the overtrust score satisfies the overtrust threshold (“yes” at step 808), the method 800 proceeds to step 810 and initiates overtrust remediation. In one highly protective embodiment, the overtrust score may be the number of phishing websites detected among the target websites, and the overtrust threshold may be zero. In this embodiment, attempting to visit even a single phishing website would satisfy the overtrust threshold (i.e. 1>0). In such an embodiment, steps 806 and 808 may be subsumed into a single step. The overtrust remediation may comprise a variety of actions. In one particular embodiment, the overtrust remediation includes locking at least one financial account associated with the individual. Other aspects of overtrust remediation may include implementation of targeted education, enhanced password control, personal verification questions and, multi-factor authentication (MFA) among others.

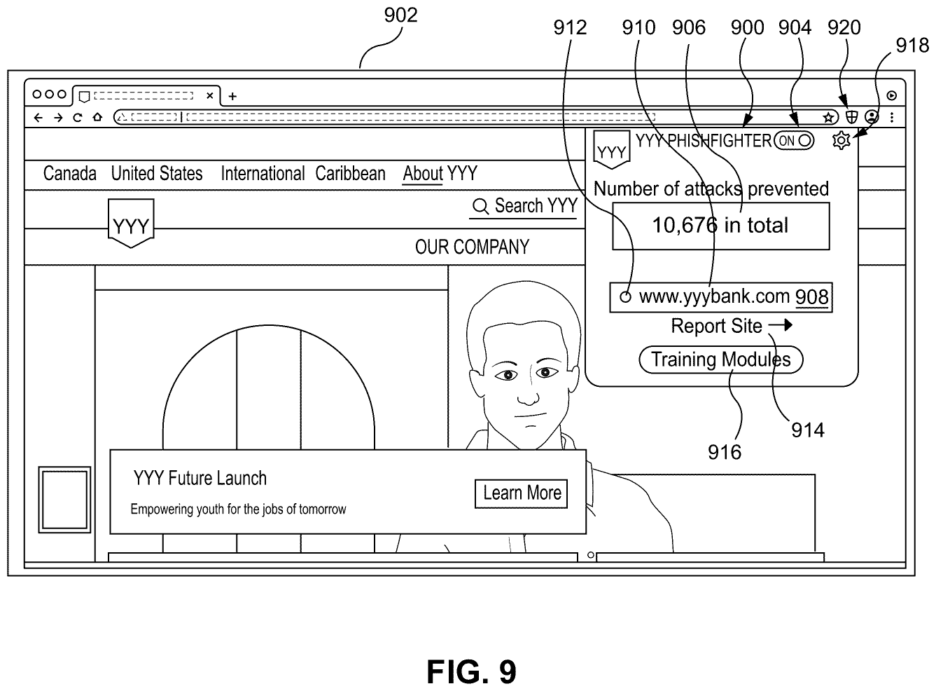

Reference is now made to FIG. 9, which shows an illustrative graphical user interface (GUI) 900 for a web browser 902 including a browser extension as described herein. The GUI 900 includes an on/off toggle 904 that allows users to temporarily turn off the browser extension, a statistic display 906 showing a number of attacks prevented, and a domain name display 908. The domain name display 908 shows the current website (domain name) 910 and includes a safety indicator 912. In the illustrated embodiment, the safety indicator 912 is a circle whose color indicates whether the website is determined to be legitimate (e.g. green) or is determined to be a phishing website (e.g. red). The GUI 900 also provides a link 914 to report a suspicious website, and another link 916 to access training modules, which may allow users to carn redeemable points while educating themselves about various phishing and privacy related attacks that they may face. A settings link 918 provides access to more advanced features. An icon 920 in the toolbar of the web browser can allow a user to access or hide the GUI 900, and may also by its color indicate whether the current website is safe even if the GUI 900 is hidden (e.g. green for “safe”, yellow for “potential threat” and red for “definite threat”, or grey if the browser extension is disabled.

Optionally, the browser extension may provide for opt-in Single Sign-On (SSO) using an encrypted one-time code unique to each instance of the extension, to be linked to a user's account at a bank, financial institution, e-commerce platform or other service.

As can be seen from the above description, the phishing detection technology described herein represents significantly more than merely using categories to organize, store and transmit information and organizing information through mathematical correlations. The phishing detection technology is in fact an improvement to Internet security technology, and therefore represents a specific solution to a computer-related problem. As such, the phishing detection technology is confined to Internet security applications.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, cach block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a training data set” or “the training data set” does not exclude embodiments in which multiple training data sets are used). It will be further understood that the terms “comprises” and “comprising”, when used in this specification, specify the presence of one or more stated features, integers, steps, operations, clements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A computer-implemented method for identifying potential phishing websites, the method comprising:
receiving a target website;
comparing a URL for the target website to at least one of a whitelist and a blacklist;
responsive to determining that the URL for the target website is not on the at least one of the whitelist and the blacklist, parsing the target website into:
Uniform Resource Locator (URL) information; and
Hypertext Markup Language (HTML) information;
identifying predetermined URL features of the URL information;
identifying predetermined HTML features of the HTML information;
receiving, from a classifier engine, a prediction as to whether the target website is a phishing website or a legitimate website;
wherein the prediction is based on the classifier engine applying the trained machine learning model to a URL prediction from an independent URL classifier as a first input and the predetermined HTML features as additional inputs, wherein the URL prediction is for whether the target website is a phishing website or a legitimate website and is based on the URL information alone; and
where the prediction predicts that the target website is a phishing website, blocking computer access to the target website.

2. The method of claim 1, wherein:
the classifier engine is specific to a single particular institution; and
the classifier engine is trained using salient features that include at least one institution-specific feature associated with the single particular institution.

3. The method of claim 2, wherein the at least one institution-specific feature includes at least one of:
a text string including at least a portion of a name of the single particular institution;
a text string including a typographically imperfect recreation of at least a portion of the name of the single particular_institution;
a text string including at least a portion of a trademark of the single particular institution;
a text string including a typographically imperfect recreation of at least a portion of a trademark of the single particular institution;
a text string including at least a portion of contact information for the single particular institution;
a text string including a typographically imperfect recreation of at least a portion of contact information for the single particular institution;
a graphical representation of an image associated with the single particular institution; and
a graphical representation of an imperfect recreation of an image associated with the single particular_institution.

4. The method of claim 1, further comprising:
responsive to determining that the URL for the target website corresponds to one of the whitelist and the blacklist:
definitively identifying the target website as a legitimate website where the URL for the target website corresponds to the whitelist; and
definitively identifying the target website as a phishing website where the URL for the target website corresponds to the blacklist; and
responsive to definitively identifying the target website as a phishing website, blocking access to the target website.

5. The method of claim 1, wherein:
the method is performed for a plurality of remote computing devices; and
the method further comprises, where the target website is predicted to be a phishing website, using a number of times unique individuals attempt to access the target website to estimate a size of a phishing campaign associated with the target website.

6. A data processing system comprising at least one processor and memory coupled to the at least one processor, wherein the memory contains instructions which, when executed by the at least one processor, cause the at least one processor to implement a method comprising:
receiving a target website;
comparing a URL for the target website to at least one of a whitelist and a blacklist;
responsive to determining that the URL for the target website is not on the at least one of the whitelist and the blacklist, parsing the target website into:
Uniform Resource Locator (URL) information; and
Hypertext Markup Language (HTML) information;
identifying predetermined URL features of the URL information;
identifying predetermined HTML features of the HTML information;
receiving, from a classifier engine, a prediction as to whether the target website is a phishing website or a legitimate website;
wherein the prediction is based on the classifier engine applying the trained machine learning model to a URL prediction from an independent URL classifier as a first input and the predetermined HTML features as additional inputs, wherein the URL prediction is for whether the target website is a phishing website or a legitimate website and is based on the URL information alone; and
where the prediction predicts that the target website is a phishing website, blocking computer access to the target website.

7. The data processing system of claim 6, wherein:
the classifier engine is specific to a single particular institution; and
the classifier engine is trained using salient features that include at least one institution-specific feature associated with the single particular institution.

8. The data processing system of claim 7, wherein the at least one institution-specific feature includes at least one of:
a text string including at least a portion of a name of the single particular institution;
a text string including a typographically imperfect recreation of at least a portion of the name of the single particular institution;
a text string including at least a portion of a trademark of the single particular institution;
a text string including a typographically imperfect recreation of at least a portion of a trademark of the single particular institution;
a text string including at least a portion of contact information for the single particular institution;
a text string including a typographically imperfect recreation of at least a portion of contact information for the single particular institution;
a graphical representation of an image associated with the single particular institution; and
a graphical representation of an imperfect recreation of an image associated with the single particular institution.

9. The data processing system of claim 6, wherein the method further comprises:
responsive to determining that the URL for the target website corresponds to one of the whitelist and the blacklist:
definitively identifying the target website as a legitimate website where the URL for the target website corresponds to the whitelist; and
definitively identifying the target website as a phishing website where the URL for the target website corresponds to the blacklist; and
responsive to definitively identifying the target website as a phishing website, blocking access to the target website.

10. The data processing system of claim 6, wherein:
the method is performed for a plurality of remote computing devices; and
the method further comprises, where the target website is predicted to be a phishing website, using a number of times unique individuals attempt to access the target website to estimate a size of a phishing campaign associated with the target website.

11. A computer program product comprising a tangible, non-transitory computer readable medium embodying instructions which, when executed by at least one processor of a data processing system, cause the data processing system to implement a method comprising:
receiving a target website;
comparing a URL for the target website to at least one of a whitelist and a blacklist;
responsive to determining that the URL for the target website is not on the at least one of the whitelist and the blacklist, parsing the target website into:
Uniform Resource Locator (URL) information; and
Hypertext Markup Language (HTML) information;
identifying predetermined URL features of the URL information;
identifying predetermined HTML features of the HTML information;
receiving, from a classifier engine, a prediction as to whether the target website is a phishing website or a legitimate website;
wherein the prediction is based on the classifier engine applying the trained machine learning model to a URL prediction from an independent URL classifier as a first input and the predetermined HTML features as additional inputs, wherein the URL prediction is for whether the target website is a phishing website or a legitimate website and is based on the URL information alone; and
where the prediction predicts that the target website is a phishing website, blocking computer access to the target website.

12. The computer program product of claim 11, wherein:
the classifier engine is specific to a single particular institution; and
the classifier engine is trained using salient features that include at least one institution-specific feature associated with the single particular institution.

13. The computer program product of claim 12, wherein the at least one institution-specific feature includes at least one of:
a text string including at least a portion of a name of the single particular institution;
a text string including a typographically imperfect recreation of at least a portion of the name of the single particular institution;
a text string including at least a portion of a trademark of the single particular institution;
a text string including a typographically imperfect recreation of at least a portion of a trademark of the single particular institution;
a text string including at least a portion of contact information for the single particular institution;
a text string including a typographically imperfect recreation of at least a portion of contact information for the single particular institution;
a graphical representation of an image associated with the single particular institution; and
a graphical representation of an imperfect recreation of an image associated with the single particular institution.

14. The computer program product of claim 11, wherein the method further comprises:
responsive to determining that the URL for the target website corresponds to one of the whitelist and the blacklist:
definitively identifying the target website as a legitimate website where the URL for the target website corresponds to the whitelist; and
definitively identifying the target website as a phishing website where the URL for the target website corresponds to the blacklist; and
responsive to definitively identifying the target website as a phishing website, blocking access to the target website.

15. The computer program product of claim 11, wherein:
the method is performed for a plurality of remote computing devices; and
the method further comprises, where the target website is predicted to be a phishing website, using a number of times unique individuals attempt to access the target website to estimate a size of a phishing campaign associated with the target website.
